(19) United States
(12) Patent Application Publication
(10) Pub. No.: US 2011/0084981 A1
(43) Pub. Date: Apr. 14, 2011

(54) SIGNAL PROCESSING APPARATUS AND PROJECTION DISPLAY APPARATUS

(75) Inventors: Takaaki ABE, Osaka-city (JP); Masutaka INOUE, Osaka (JP)

(73) Assignee: SANYO ELECTRIC CO., LTD, Moriguchi-shi (JP)

(21) Appl. No.: 12/951,204

(22) Filed: Nov. 22, 2010

Related U.S. Application Data
(63) Continuation-in-part of application No. PCT/JP2009/059439, filed on May 22, 2009.

(30) Foreign Application Priority Data
May 22, 2008 (JP) 2008-134827

(51) Int. Cl. G09G 5/02

(52) U.S. Cl. 345/590

(57) ABSTRACT

A signal processing apparatus (200) is provided with a color coordinate adjusting unit (210) which performs color coordinate adjusting processing according to the color space of a display device, a luminance adjusting unit(220) which performs luminance adjusting processing, a display element control unit (240) which generates an image output signal on the basis of the color coordinates adjusted by the color coordinate adjusting processing and luminance components adjusted by the luminance adjusting processing, and a ratio control unit (230) which controls according to the saturation of an image input signal the degree of contribution of color coordinate adjustment which is provided by the color coordinate adjusting processing to the image output signal and the degree of contribution of the luminance components which is provided by the luminance adjusting processing to the image output signal. With the increase of the color saturation of an image input signal in a specific hue, the ratio control unit (230) increases the degree of contribution of the luminance components and reduces the degree of contribution of the color coordinate adjustment.

### TECHNICAL FIELD

The present invention relates to a signal processing apparatus, which converts an image input signal to an image output signal, and a projection display apparatus.

### BACKGROUND ART

A display device, which displays an image acquired by means of an image pickup device such as a camera, is conventionally known. A solid light source with its color space (for example, LD: Laser Diode or LED: Light Emitting Diode) is developed as a light source for irradiating the display device with light. A case in which the color space of such a display device is different from that of the image pickup device is presupposed.

On the other hand, there is proposed a technique of reducing a color space of an input device in a case where the color space of the input device (for example, image pickup device) is wider than that of an output device (for example, display device) (for example, Japanese Patent Application Publication No. 2000-324350). Specifically, a visually and naturally viewable image is outputted by changing a direction of reducing the color space on a hue-by-hue basis.

Here, let us consider a case in which the color space of the output device (for example, display device) is wider than that of the input device (for example, image pickup device). In such a case, if the output device displays an image in accordance with an image input signal inputted from the input device, a color coordinate of the image widens more significantly than a real color coordinate. The color coordinate is a coordinate specified by saturation and hue.

On the other hand, it is also considered to apply the above-described technique in order to make the color coordinate of the image close to the real color coordinate. However, if the color space of the output device is merely reduced, the color space of the output device (display device) is not effectively utilized.

### SUMMARY OF THE INVENTION

A signal processing apparatus of a first aspect configured to convert an image input signal to an image output signal and output the image output signal to a display device. The signal processing apparatus includes: a color coordinate adjusting unit (color coordinate adjusting unit 210) configured to perform a color coordinate adjusting processing of adjusting a color coordinate of the image input signal, in accordance with a color space of the display device; a luminance adjusting unit (luminance adjusting unit 220) configured to perform a luminance adjusting processing of adjusting a luminance component of the image input signal; an output signal generating unit (display element control unit 240) configured to generate the image output signal, in accordance with the color coordinate adjusted by the color coordinate adjusting processing and the luminance component adjusted by the luminance adjusting processing; and a control unit (ratio control unit 230) configured to control a contribution degree of color coordinate adjustment, which the color coordinate adjusting processing imparts to the image output signal, and a contribution degree of a luminance component, which the luminance adjusting processing imparts to the image output signal, in accordance with saturation of the image input signal. The control unit increases the contribution degree of the luminance component and reduces the contribution degree of the color coordinate adjustment, as the saturation of the image input signal is higher in a specific hue.

The signal processing apparatus of the first aspect further includes an acquisition unit (acquisition unit 250) configured to acquire a luminance of an image in accordance with the image input signal. The control unit lowers amount of the luminance component of the image input signal in the luminance adjusting processing, as the luminance acquired by the acquisition unit is higher.

The signal processing apparatus of the first aspect, further includes an acquisition unit (acquisition unit 250) configured to acquire a hue in a respective one of pixels configuring an image, in accordance with the image input signal. The specific hue has a predetermined hue range including a target hue. The control unit increases the contribution degree of the luminance component and reduces the contribution degree of the color coordinate adjustment, as the hue acquired by the acquisition unit is closer to the target hue.

The signal processing apparatus of the first aspect, further includes an acquisition unit (acquisition unit 250) configured to acquire a hue in a respective one of pixels configuring an image, in accordance with the image input signal. The control unit increases the contribution degree of the luminance component and reduces the contribution degree of the color coordinate adjustment, as a hue distribution range is wider, the hue distribution range is a distributed range of the hue acquired by the acquisition unit in the specific hue.

The signal processing apparatus of the first aspect, further includes an acquisition unit (acquisition unit 250) configured to acquire saturation in a respective one of pixels configuring an image, in accordance with the image input signal. The control unit increases the contribution degree of the luminance component and reduces the contribution degree of the color coordinate adjustment, as the saturation acquired by the acquisition unit is higher.

The signal processing apparatus of the first aspect, further includes an acquisition unit (acquisition unit 250) configured to acquire saturation in a respective one of pixels configuring an image, in accordance with the image input signal. The control unit increases the contribution degree of the luminance component and reduces the contribution degree of the color coordinate adjustment, as a saturation distribution range is wider, the saturation distribution range is a distributed range of the saturation acquired by the acquisition unit in the specific hue.

In the signal processing apparatus of the first aspect, the control unit controls the contribution degree of the luminance component and the contribution degree of the color coordinate adjustment in a respective one of pixels.

A projection display apparatus of a second aspect, includes: a signal processing apparatus of the first aspect; a display device for displaying an image in accordance with an image output signal outputted from the signal processing apparatus; and a projection means for projecting the image displayed by the display device.

### BRIEF DESCRIPTION OF THE DRAWINGS

FIG. 1 is a view showing a configuration of a projection display apparatus according to a first embodiment.

FIG. 2 is a view showing a general color space showing hue and saturation.

FIG. 3 is a view showing a color space of a liquid crystal panel 30 according to the first embodiment.

FIG. 4 is a block diagram depicting a configuration of a signal processing apparatus 200 according to the first embodiment.

FIG. 5 is a view showing a parameter α according to the first embodiment.

FIG. 6 is a flowchart showing an operation of the signal processing apparatus 200 according to the first embodiment.

FIG. 7 is a block diagram depicting a configuration of a signal processing apparatus 200 according to a second embodiment.

FIG. 8 is a view showing a parameter Lum according to the second embodiment.

FIG. 9 is a block diagram depicting a configuration of a signal processing apparatus 200 according to a third embodiment.

FIG. 10 is a view showing a hue gain (GAIN_{H (m,n)}) according to the third embodiment.

FIG. 11 is a view showing a saturation gain (GAIN_{S (m,n)}) according to the third embodiment.

FIG. 12 is a view showing a parameter β according to the third embodiment.

FIG. 13 is a block diagram depicting a configuration of a signal processing apparatus 200 according to a fourth embodiment.

FIG. 14 is a view showing a hue distribution range RANGE_{H} according to the fourth embodiment.

FIG. 15 is a view showing a saturation distribution range RANGE_{S} according to the fourth embodiment.

FIG. 16 is a view showing a hue gain GAIN_{H} according to the fourth embodiment.

FIG. 17 is a view showing a saturation gain GAIN_{S} according to the fourth embodiment.

FIG. 18 is a block diagram depicting a configuration of a signal processing apparatus 200 according to a fifth embodiment.

FIG. 19 is a view showing a luminance gain GAIN_{L (m, n)} according to the fifth embodiment.

FIG. 20 is a view showing a hue gain GAIN_{H (m, n)} according to the fifth embodiment.

FIG. 21 is a view showing a saturation gain GAIN_{S (m, n)} according to the fifth embodiment.

FIG. 22 is a flowchart showing an operation of the signal processing apparatus 200 according to the fifth embodiment.

### EMBODIMENT FOR CARRYING OUT THE INVENTION

Hereinafter, a projection display apparatus according to embodiments of the present invention will be described with reference to the drawings. In the following description of the drawings, the same or similar constituent elements are designated by the same or similar reference numerals.

It should be noted that the drawings are schematic and ratios of dimensions and the like are different from actual ones. Therefore, specific dimensions and the like should be determined in consideration of the following description. Moreover as a matter of course, the drawings also include portions having different dimensional relationships and ratios from each other.

### First Embodiment

### Configuration of Projection Display Apparatus

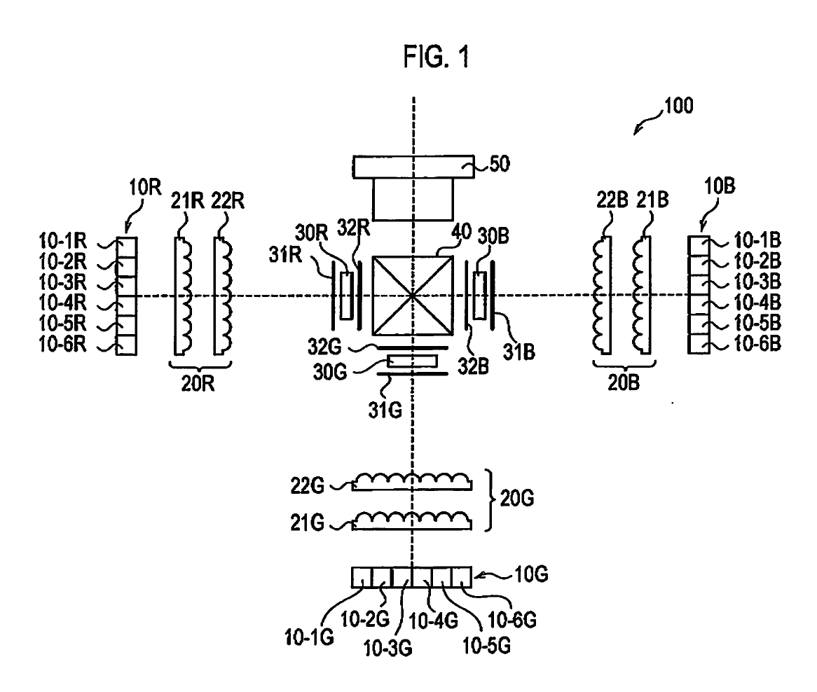

Hereinafter, a configuration of a projection display apparatus according to a first embodiment will be described with reference to the drawings. FIG. 1 is a view showing a configuration of a projection display apparatus 100 according to the first embodiment.

As shown in FIG. 1, the projection display apparatus has: a plurality of light source units 10; a plurality of fly-eye lens units 20; a plurality of liquid crystal panels 30 a cross-dichroic prism 40; and a projection lens unit 50.

The plurality of light source units 10 are a light source unit 10R, a light source unit 10G, and a light source unit 10B. A respective one of the light source units 10 is a unit configured with a plurality of solid light sources. A respective one of the solid light sources is an LD (Laser Diode) or an LED (Light Emitting Diode), for example. The light source unit 10R is configured with a plurality of solid light sources 10-1R to 10-6R) which emit red component light. The light source unit 10G is configured with a plurality of solid light sources 10-1G to 10-6G) which emit green component light. The light source unit 10B is configured with a plurality of solid light sources (10-1B to 10-6B) which emit blue component light.

The plurality of fly-eye lens units 20 is a fly-eye lens unit 20R, a fly-eye lens unit 20G, and a fly-eye lens unit 20B. A respective one of the fly-eye lens units 20 is configured with a fly-eye lens 21 and a fly-eye lens 22. The fly-eye lens 21 and the fly-eye lens 22 are configured with a plurality of micro-lenses, respectively. A respective one of the micro-lenses focuses light which a respective one of the light source units 10 emits so that the light which a respective one of the light source units 10 emits is irradiated all over a respective one of the liquid crystal panels 30.

The plurality of liquid crystal panels 30 are a liquid crystal panel 30R, a liquid crystal panel 30G, and a liquid crystal panel 30B. The liquid crystal panel 30R modulates red component light by rotating a polarization direction of red component light. An incidence-side polarization plate 31R for transmitting light having one polarization direction (for example, P-polarization) and interrupting light having the other polarization direction (for example, S-polarization) is provided at the light incidence face side of the liquid crystal panel 30R. An emission-side polarization plate 32R for interrupting light having one polarization direction (for example, P-polarization) and transmitting light having the other polarization direction (for example, S-polarization) is provided at the light emission face side of the liquid crystal panel 30R.

Similarly, the liquid crystal panel 30G and the liquid crystal panel 30B modulate green component light and blue component light by rotating the polarization direction of green component light and blue component light, respectively. An incidence-side polarization plate 31G is provided at the light incidence face side of the liquid crystal panel 30G, and an emission-side polarization plate 32G is provided at the light emission face side of the liquid crystal panel 30G. An incidence-side polarization plate 31B is provided at the light incidence face side of the liquid crystal panel 30B, and an emission-side polarization plate 32B is provided at the light emission face side of the liquid crystal panel 30B.

The cross-dichroic prism 40 combines the light emitted from the liquid crystal panel 30R, the liquid crystal panel 30G, and the liquid crystal panel 30B with each other. The cross-dichroic prism 40 emits the combined light to the side of a projection lens unit 50.

The projection lens unit 50 projects, onto a screen or the like, the combined light (image light) emitted from the cross-dichroic prism 40.

(Hue and Saturation)

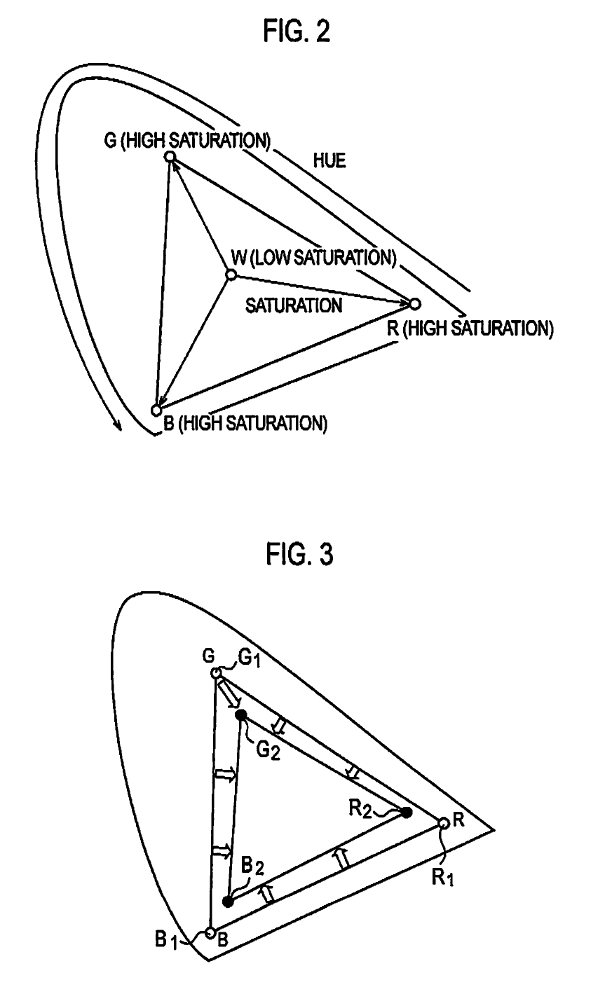

Hereinafter, hue and saturation according to the first embodiment will be described with reference to the drawings. FIG. 2 is a view showing a general color space indicating hue and saturation. In FIG. 2, a point W is a point indicating white. A point R, a point G, and a point B are points indicating red, green, and blue, respectively.

As shown in FIG. 2, hue is represented by an angle formed by the point W and an outer periphery of the color space. Saturation is the lowest value at the point W and increases with distance from the point W.

Incidentally, an image input signal is inputted from an input device (such as image pickup device, for example) to the projection display apparatus 100 according to the first embodiment.

The color space of the liquid crystal panel 30 depends upon the light emitted from a respective one of the light source units 10. That is, the higher the color purity of the light emitted from a respective one of the light source units 10 is, the wider the color space of the liquid crystal panel 30 is. On the other hand, the color space of the input device depends upon precision of an image pickup element or the like, which is provided in the input device.

In the first embodiment, as shown in FIG. 3, let us consider a case in which a color space (R₁, G₁, B₁) of the liquid crystal panel 30 is wider than a color space (R₂, G₂, B₂) of the input device.

(Functions of Projection Display Apparatus)

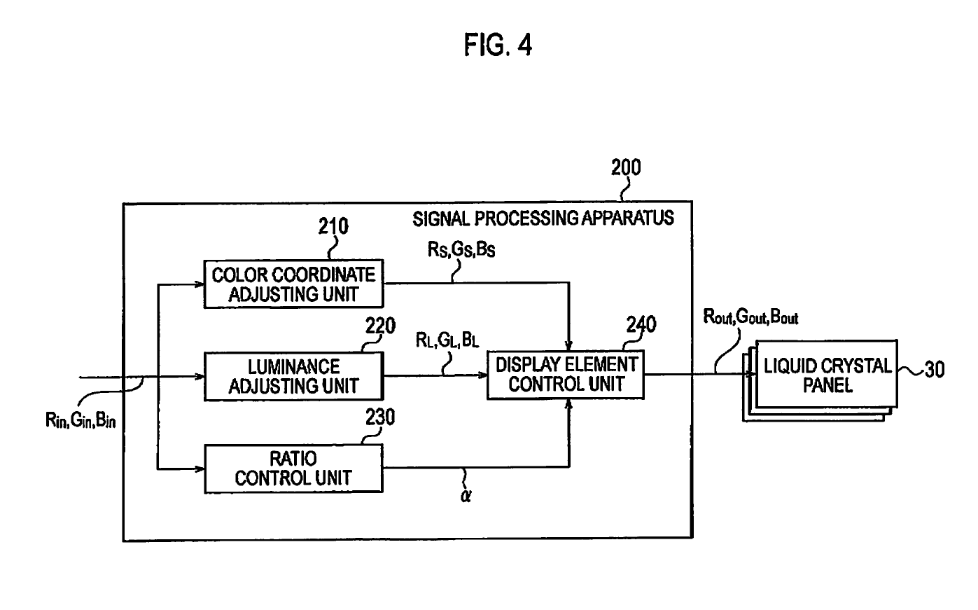

Hereinafter, functions of the projection display apparatus according to the first embodiment will be described with reference to the drawings. FIG. 4 is a block diagram depicting the functions of the projection display apparatus 100 (signal processing apparatus 200) according to the first embodiment.

The signal processing apparatus 200 acquires image input signals including a red input signal Rᵢₙ, a green input signal Gᵢₙ, and a blue input signal Bᵢₙ. The signal processing apparatus 200 outputs image output signals including a red output signal Rₒᵤₜ, a green output signal Gₒᵤₜ, and a blue output signal Bₒᵤₜ. The red input signal Rᵢₙ, the green input signal Gᵢₙ, and the blue input signal Bᵢₙ are the values which ranges from the lowest luminance (for example, “0”) to the highest luminance (for example, “255”), respectively. Similarly, the red output signal Bₒᵤₜ, the green output signal Gₒᵤₜ, and the blue output signal Bₒᵤₜ are the values which ranges from the lowest luminance (for example, “0”) to the highest luminance (for example, “255”), respectively.

As shown in FIG. 4, the signal processing apparatus 200 has a color coordinate adjusting unit 210, a luminance adjusting unit 220, a ratio control unit 280, and a display element control unit 240.

The color coordinate adjusting unit 210 performs color coordinate adjusting processing of adjusting a color coordinate of an image input signal, in accordance with a difference between a color space of the liquid crystal panel 30 and a color space of the input device. The color coordinate is a coordinate specified by saturation and hue, indicating a position in a closed curve enclosed by single color light trajectory (or spectrum trajectory) in a color distribution chart as shown in FIG. 2. Here, it is presupposed that the color space of the input device is already known. Therefore, the color coordinate adjusting unit 210 performs color coordinate adjusting processing in accordance with the color space of the liquid crystal panel 30. The color coordinate adjusting processing is processing of reducing the color coordinate of an image input signal in order to restrain distortion of the color coordinate which may occur due to the difference in color space. Specifically, the color coordinate adjusting processing is processing of changing the above-described position in the dosed curve by adjusting saturation and hue.

For example, the color coordinate adjusting unit 210 performs color coordinate adjusting processing in accordance with formula (1) below. In the formula, R_{S}, G_{S}, and B_{S} designate color coordinate adjustment signals corresponding to red, green, and blue, respectively.

$$\begin{matrix}[ Formula 1 ] & \\ ( \begin{matrix}{R}_{S} \\ {G}_{S} \\ {B}_{S}\end{matrix} ) = ( \begin{matrix}a & b & c \\ d & e & f \\ g & h & i\end{matrix} ) \times ( \begin{matrix}{R}_{in} \\ {G}_{in} \\ {B}_{in}\end{matrix} ) & Formula 1\end{matrix}$$

Parameters a to i are constants which are defined according to the color space of the liquid crystal panel 30 and the input device.

The luminance adjusting unit 220 performs luminance adjusting processing of adjusting luminance components of an image input signal. The luminance adjusting processing is processing of reducing luminance components of an image input signal in order to restrain glare of a color with its high saturation (purity).

For example, the luminance adjusting unit 220 performs luminance adjusting processing in accordance with formula (2) below. In the formula, R_{L}, G_{L}, and B_{L} designate luminance adjustment signals corresponding to red, green, and blue, respectively.

$$\begin{matrix}[ Formula 2 ] & \\ ( \begin{matrix}{R}_{L} \\ {G}_{L} \\ {B}_{L}\end{matrix} ) = Lum \times ( \begin{matrix}{R}_{in} \\ {G}_{in} \\ {B}_{in}\end{matrix} ) & Formula ( 2 )\end{matrix}$$

A parameter Lum is a constant defining a lowered amount of luminance components of an image input signal. The parameter Lum is a value which ranges from the minimum value to 1. The minimum value is a value which ranges from 0 to 1. The lowered amount of the luminance components of the image input signal is augmented, as the parameter Lum is smaller.

The ratio control unit 230 controls a contribution degree of the color coordinate adjustment and a contribution degree of the luminance components. The contribution degree of the color coordinate adjustment is a contribution degree in which color coordinate adjusting processing (color coordinate adjustment signal) imparts to an image output signal. The contribution degree of the luminance components is a contribution degree which luminance adjusting processing (luminance adjustment signal) imparts to an image output signal.

Here, the ratio control unit 230 controls a contribution degree of the color coordinate adjustment (1−α) and a contribution degree of the luminance components (α) in accordance with the hue and saturation of an image input signal. The value for a is in the range from 0 to 1.

Specifically, the ratio control unit 230 acquires the hue and saturation of an image input signal on a pixel-by-pixel basis. The ratio control unit 230 counts the number of pixels whose saturation exceeds a predetermined threshold value in a specific hue (blue hue in this case) by means of a determination counter.

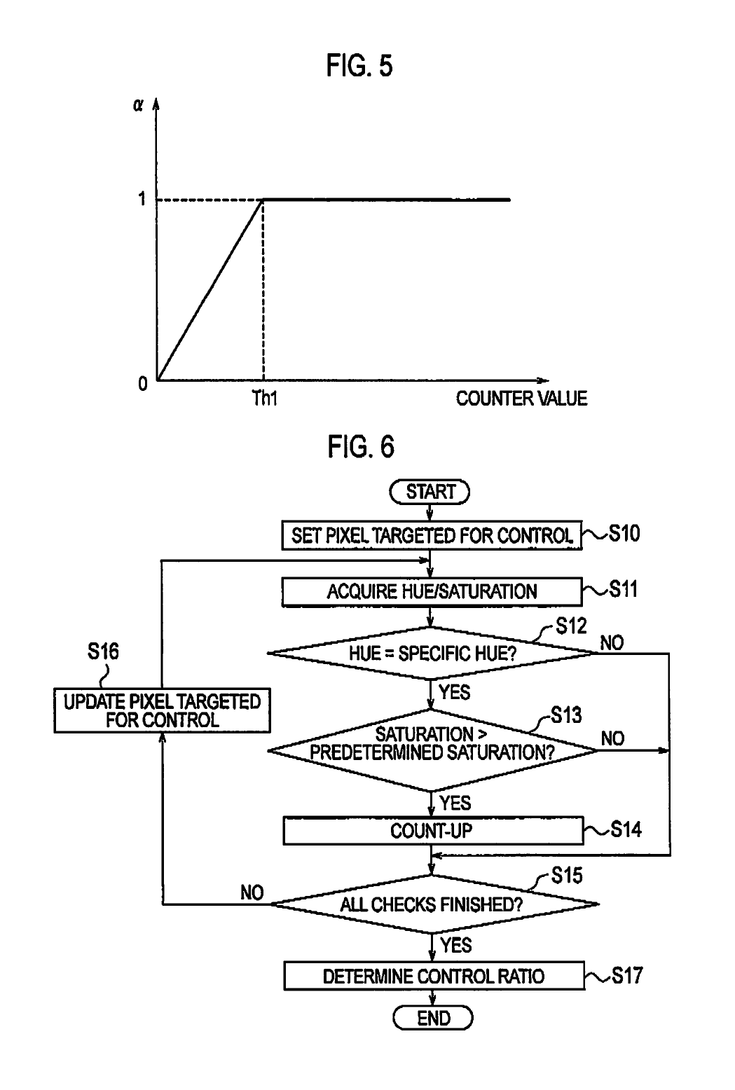

The ratio control unit 230, as shown in FIG. 5, increases a value for parameter α until the counted value of the determination counter is acquired as a threshold value Th1. On the other hand, the ratio control unit 230 maintains the value for parameter α at its maximum value (=1) if the counted value of the determination counter exceeds the threshold value Th1.

The display element control unit 240 acquires an image output signal by way of a color coordinate (color coordinate adjustment signal) adjusted by means of the color coordinate adjusting unit 210; and luminance components (luminance adjustment signal) adjusted by means of the luminance adjusting unit 220. The display element control unit 240 controls a ratio of a color coordinate adjustment signal and a luminance adjustment signal in accordance with the parameter α acquired from the ratio control unit 230.

For example, the display element control unit 240 acquires an image output signal in accordance with formula (3) below.

$$\begin{matrix}[ Formula 3 ] & \\ ( \begin{matrix}{R}_{out} \\ {G}_{out} \\ {B}_{out}\end{matrix} ) = ( 1 - α ) \times ( \begin{matrix}{R}_{S} \\ {G}_{S} \\ {B}_{S}\end{matrix} ) + α \times ( \begin{matrix}{R}_{L} \\ {G}_{L} \\ {B}_{L}\end{matrix} ) & Formula ( 3 )\end{matrix}$$

(Operation of Projection Display Apparatus)

Hereinafter, an operation of the projection display apparatus according to the first embodiment will be described with reference to the drawings. FIG. 6 is a flowchart showing functions of the projection display apparatus 100 (signal processing apparatus 200) according to the first embodiment.

As shown in FIG. 6, in step 10, among a plurality of pixels each configuring an image (frame), the signal processing apparatus 200 sets any pixel as a pixel targeted for control.

In step 11, the signal processing apparatus 200 acquires the hue and saturation of the pixel targeted for control, in accordance with an image input signal of the pixel targeted for control.

In step 12, the signal processing apparatus 200 determines whether or not the hue acquired in step 11 is a specific hue (blue hue in this case). In a case where the hue is the specific hue, the signal processing apparatus 200 migrates to the processing of step 13. On the other hand, in a case where the hue is not the specific hue, the device migrates to the processing of step 15.

In step 13, the signal processing apparatus 200 determines whether or not the saturation acquired in step 11 exceeds a predetermined threshold value. In a case where the saturation exceeds the predetermined threshold value, the signal processing apparatus 200 migrates to the processing of step 14. On the other hand, in a case where the saturation does not exceed the predetermined threshold value, the signal processing apparatus 200 migrates to the processing of step 15.

In step 14, the signal processing apparatus 200 performs count-up of the determination counter. Specifically, the signal processing apparatus 200 adds “1” to the counted value of the determination counter.

In step 15, the signal processing apparatus 200 determines whether or not checks have been finished as to all of the pixels each configuring an image (frame). In a case where the checks have been finished as to all of the pixels, the signal processing apparatus 200 migrates to the processing of step 17. On the other hand, in a case where the checks have not been finished as to all of the pixels, the signal processing apparatus 200 migrates to the processing of step 16.

In step 16, the signal processing apparatus 200 updates a pixel targeted for control. For example, the signal processing apparatus 200 shifts a pixel targeted for control in a horizontal direction or in a vertical direction.

In step 17, the signal processing apparatus 200 determines a control ratio (α) between a contribution degree of the color coordinate adjustment and a contribution degree of the luminance components. Specifically, the signal processing apparatus 200, as shown in FIG. 5, determines the control ratio (α) in accordance with the counted value of the determination counter.

### FUNCTION(S) AND ADVANTAGEOUS EFFECT(S)

In the first embodiment, the ratio control unit 230 increases the contribution degree of the luminance components and reduces the contribution degree of the color coordinate adjustment in a case where the saturation of an image input signal is higher than a predetermined threshold value in a specific hue (for example, blue hue), i.e., in a case where a difference between an image color coordinate and a real color coordinate is great.

Therefore, in the case where the difference between the image color coordinate and the real color coordinate is great, the glare in color with its high saturation (purity) can be restrained in a specific hue (for example, blue hue in this case). Further, the color space of the liquid crystal panel 30 can be effectively utilized by restraining reduction of a color coordinate.

On the other hand, the ratio control unit 230 reduces the contribution degree of the luminance components in a case where the saturation of an image input signal is lower than a predetermined threshold value in a specific hue (for example, blue hue), i.e., in a case where a difference between an image color coordinate and a real color coordinate is small.

Therefore, the lowering of an image luminance can be restrained in the case where the difference between the image color coordinate and the real color coordinate is small.

### Second Embodiment

Hereinafter, a second embodiment will be described with reference to the drawings. Hereinafter, differences between the first embodiment and the second embodiment will be mainly described.

Specifically, in the above-described first embodiment, the parameter Lum employed in luminance adjusting processing is a constant. In contrast to this, in the second embodiment, a parameter Lum employed in luminance adjusting processing is defined in accordance with an average luminance of a plurality of pixels each configuring an image (frame).

(Functions of Projection Display Apparatus)

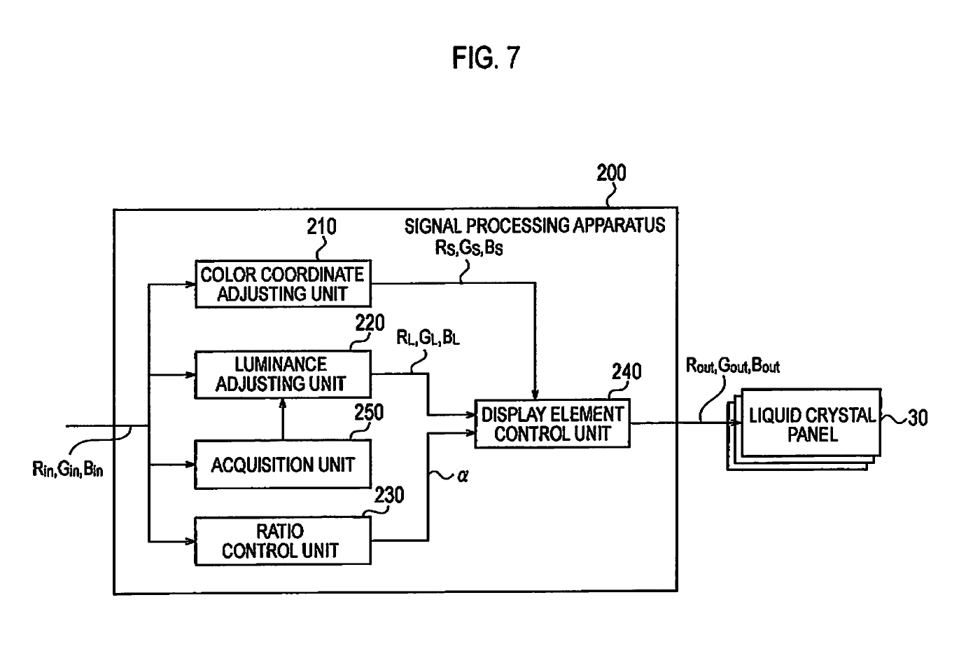

Hereinafter, functions of a projection display apparatus according to the second embodiment will be described with reference to the drawings. FIG. 7 is a block diagram depicting functions of a projection display apparatus 100 (signal processing apparatus 200) according to the second embodiment. In FIG. 7, like constituent elements shown in FIG. 4 are designated by like reference numerals.

As shown in FIG. 7, in addition to the constituent elements shown in FIG. 4, the signal processing apparatus 200 has an acquisition unit 250. The acquisition unit 250 acquires an average luminance of a plurality of pixels each configuring an image (frame), in accordance with an image input signal.

(Parameter Lum)

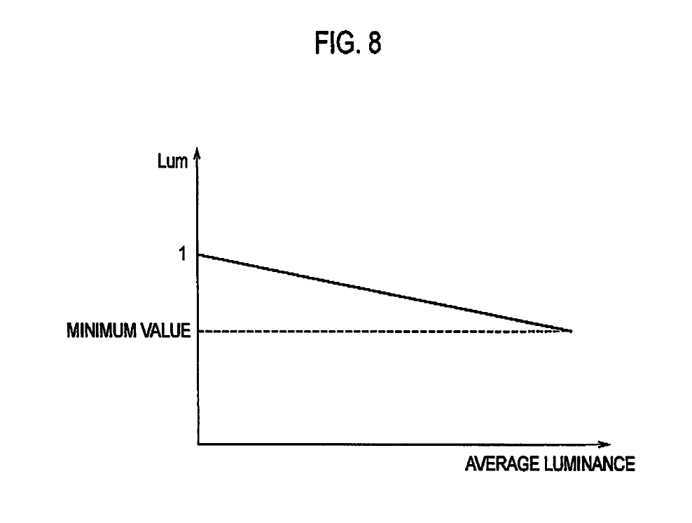

Hereinafter, parameter Lum according to the second embodiment will be described with reference to the drawings. FIG. 8 is a view showing the parameter Lum according to the second embodiment.

As shown in FIG. 8, the above-described luminance adjusting unit 220 determines the parameter Lum in accordance with the average luminance of a plurality of pixels each configuring an image (frame). Specifically, the luminance adjusting unit 220 determines the parameter Lum to a smaller value, as the average luminance becomes higher. That is, the luminance adjusting unit 220 augmented the lowered amount of the luminance components of the image input signal, as the average luminance is higher.

Like the first embodiment, the parameter Lum is a value which ranges from the minimum value to 1. The minimum value ranges from 0 to 1.

### FUNCTION(S) AND ADVANTAGEOUS EFFECT(S)

In the second embodiment, the luminance adjusting unit 220 determines the parameter Lum to a smaller value as the average luminance is higher. That is, in a high-luminance image in which glaring is prone to occur, the lowered amount of the luminance components of the image input signal is augmented. On the other hand, in a low-luminance image in which glaring is not prone to occur, the lowered amount of the luminance components of the image input signal is lessened. Therefore, glaring can be restrained while a luminance is improved to some extent.

### Third Embodiment

Hereinafter, a third embodiment will be described with reference to the drawings. Hereinafter, differences between the first embodiment described above and the third embodiment will be mainly described.

Specifically, the above-described control ratio (α) of the contribution degree of the luminance components, according to the first embodiment is defined in accordance with the counted value of the determination counter. In contrast to this, the control ratio (β) of the contribution degree of luminance components, according to the third embodiment, is defined on an image-by-image basis, in accordance with a hue gain GAIN_{H(m, n)} and a saturation gain GAIN_{s(m, n)} which are acquired on a pixel-by-pixel basis.

(Functions of Projection Display Apparatus)

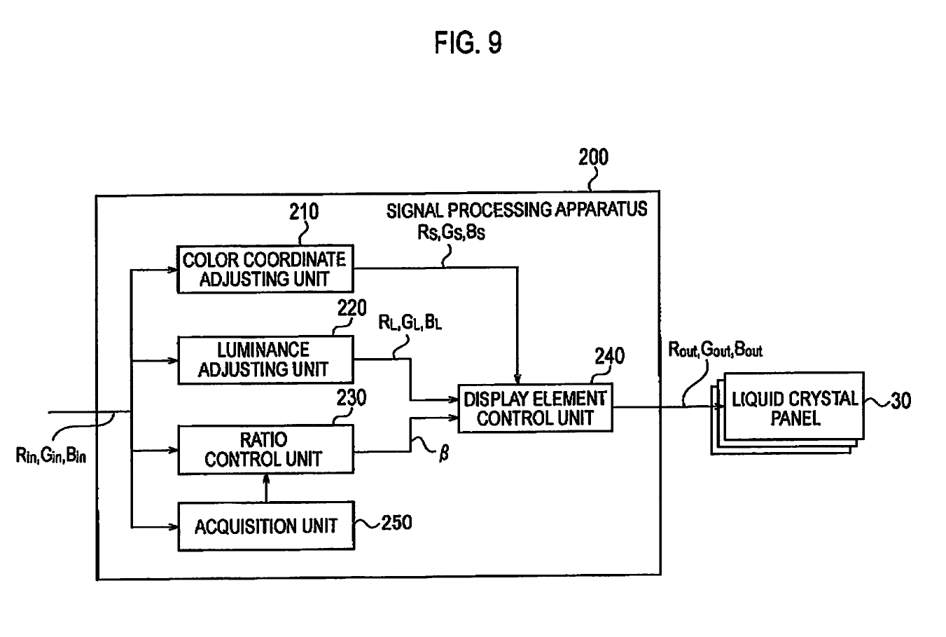

Hereinafter, functions of a projection display apparatus according to the third embodiment will be described with reference to the drawings. FIG. 9 is a block diagram depicting functions of a projection display apparatus 100 (signal processing apparatus 200) according to the third embodiment. In FIG. 9, like constituent elements shown in FIG. 4 are designated by like reference numerals.

As shown in FIG. 9, in addition to the constituent elements shown in FIG. 4, the signal processing apparatus 200 has an acquisition unit 250.

The acquisition unit 250 acquires various items of information in accordance with an image input signal. Specifically, the acquisition unit 250 acquires: (1) hue of a pixel (m, n) configuring an image (frame); and (2) saturation of the pixel (m, n) configuring an image (frame).

Here, the above-described ratio control unit 230 acquires a parameter α_{(m, n)} corresponding to the pixel (m,n) in accordance with hue and saturation.

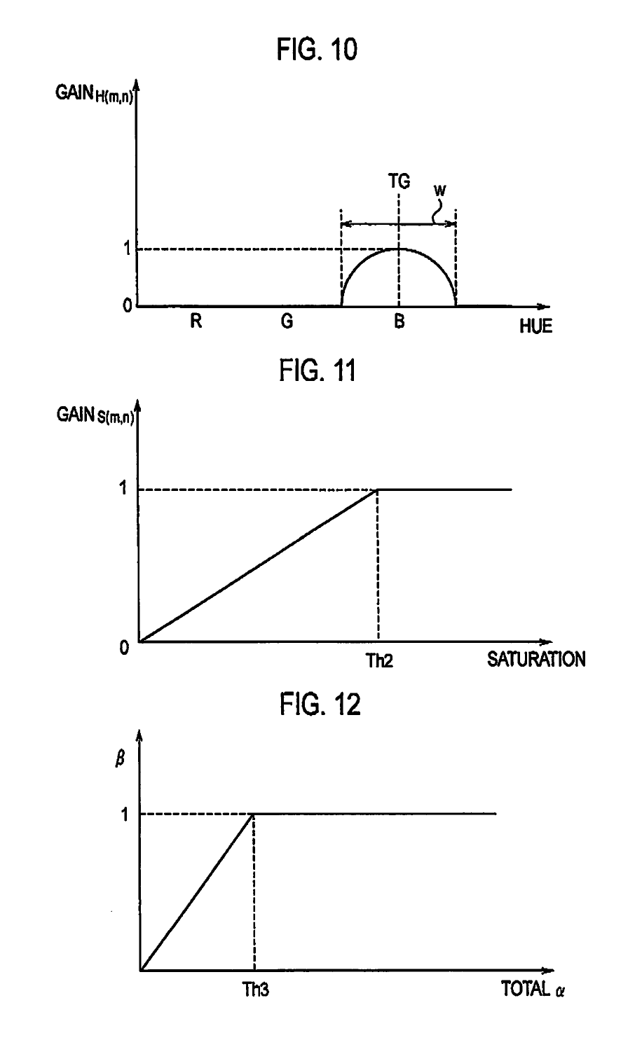

Specifically, the ratio control unit 230, as shown in FIG. 10, acquires a hue gain (GAIN_{H(m, n)}) in accordance with the hue of the pixel (m, n). Here, a specific hue (blue hue in this case) has a predetermined hue range ω including a target hue TG. The hue gain (GAIN_{H(m, n)}) is acquired as a higher value as the hue is closer to the target hue TG. The hue gain (GAIN_{H(m, n)}) is a value which ranges from 0 to 1.

The ratio control unit 230, as shown in FIG. 11, acquires a saturation gain (GAIN_{S(m, n)}) in accordance with saturation of the pixel (m, n). The saturation gain (GAIN_{S(m, n)}) is acquired as a higher value as saturation is higher until saturation is acquired as a threshold value Th2. On the other band, the saturation gain (GAIN_{S(m, n)}) is maintained at its maximum value (=1) when saturation exceeds the threshold value Th2. The saturation gain (GAIN_{S(m, n)}) is a value which ranges from 0 to 1.

The ratio control unit 230 acquires an parameter α_{(m, n)} corresponding to the pixel (m, n), in accordance with the hue gain (GAIN_{H(m, n)}) and the saturation gain (GAIN_{S(m, n)}). For example, the ratio control unit 230 acquires the parameter α_{(m, n)} corresponding to the pixel (m, n) in accordance with formula (4) below.

[Formula 4]

α_{(m, n)}=GAIN_{L}×GAIN_{H(m,n)}×GAIN_{S(m,n)} Formula (4)

Subsequently, the ratio control unit 230 acquires an additive value (TOTAL) by adding the parameter α_{(m, n)} of all pixels (m, n) configuring an image (frame). That is, the ratio control unit 230 acquires an additive value (TOTAL) in accordance with formula (5) below.

$$\begin{matrix}[ Formula 5 ] & \\ TOTAL α = {\sum }_{m = 1 , n = 1}^{MN} α ( m , n ) & Formula ( 5 )\end{matrix}$$

where M,N is a maximum value of m, n.

The ratio control unit 230, as shown in FIG. 12, acquires a parameter β by image (frame) in accordance with the additive value (TOTAL_{α}). The parameter β is acquired as a higher value as the additive value (TOTAL_{α}) is greater. On the other hand, the parameter β is maintained at its maximum value (=1) if the saturation exceeds a threshold value Th3. The parameter β is a value which ranges from 0 to 1.

Therefore, the ratio control unit 230 increases the contribution degree of luminance components and reduces the contribution degree of color coordinate adjustment as the hue is closer to the target hue TG1. In addition, the ratio control unit 230 increases the contribution degree of luminance components and reduces the contribution degree of color coordinate adjustment as the saturation is higher.

The display element control unit 240 controls a ratio of a color coordinate adjustment signal and a luminance adjustment signal about an image in accordance with the parameter β acquired from the ratio control unit 230.

For example, the display element control unit 240 acquires an image output signal in accordance with formula (6) below.

$$\begin{matrix}[ Formula 6 ] & \\ ( \begin{matrix}{R}_{out} \\ {G}_{out} \\ {B}_{out}\end{matrix} ) = ( 1 - β ) \times ( \begin{matrix}{R}_{S} \\ {G}_{S} \\ {B}_{S}\end{matrix} ) + β \times ( \begin{matrix}{R}_{L} \\ {G}_{L} \\ {B}_{L}\end{matrix} ) & Formula ( 6 )\end{matrix}$$

### FUNCTION(S) AND ADVANTAGEOUS EFFECT(S)

In the third embodiment, the ratio control unit 230 increases the contribution degree of luminance components and reduces the contribution degree of color coordinate adjustment as the hue is closer to the target hue TG. Therefore, a glare in pixel of a hue closer to the target hue TG is restrained and the color coordinate of a pixel with its high saturation is constricted, whereby an image can be restrained from becoming unnatural.

In addition, the ratio control unit 230 increases the contribution degree of color coordinate adjustment and reduces the contribution degree of luminance components as the saturation is higher. Therefore, a glare in pixel with its high saturation (purity) is restrained and the color coordinate of a pixel with its high saturation is constricted, whereby an image can be restrained from becoming unnatural.

### Fourth Embodiment

Hereinafter, a fourth embodiment will be described with reference to the drawings. Hereinafter, differences between the first embodiment described above and the fourth embodiment will be mainly described.

Specifically, the above-described control ratio (α) of the contribution degree of luminance components, according to the first embodiment, is defined in accordance with the counted value of the determination counter. In contrast to this, a control ratio (γ) of the contribution degree of luminance components, according to the fourth embodiment, is defined on a image-by-image basis in accordance with a hue distribution range RANGE_{H} and a saturation distribution range RANGE_{S} which are acquired on an image-by-image basis.

(Functions of Projection Display Apparatus)

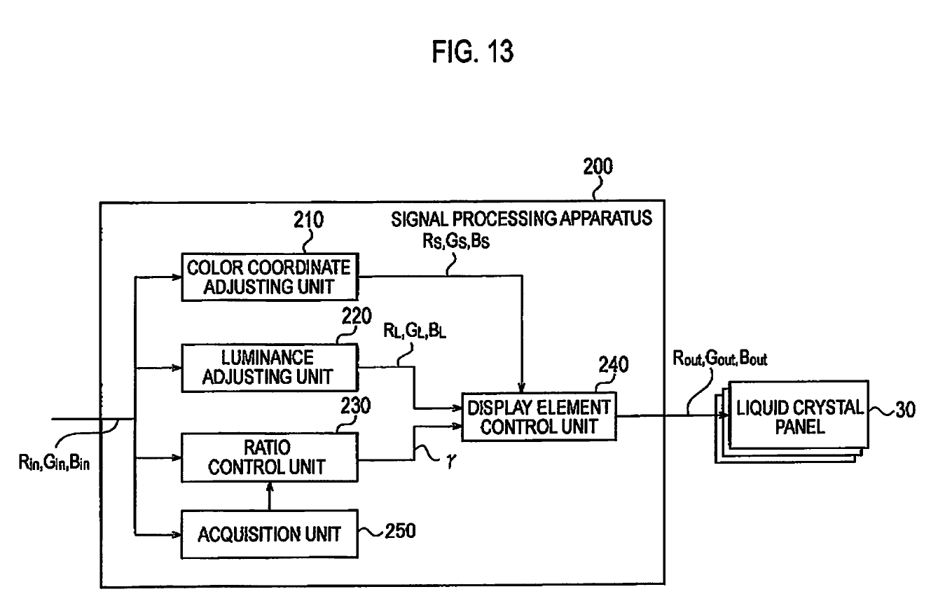

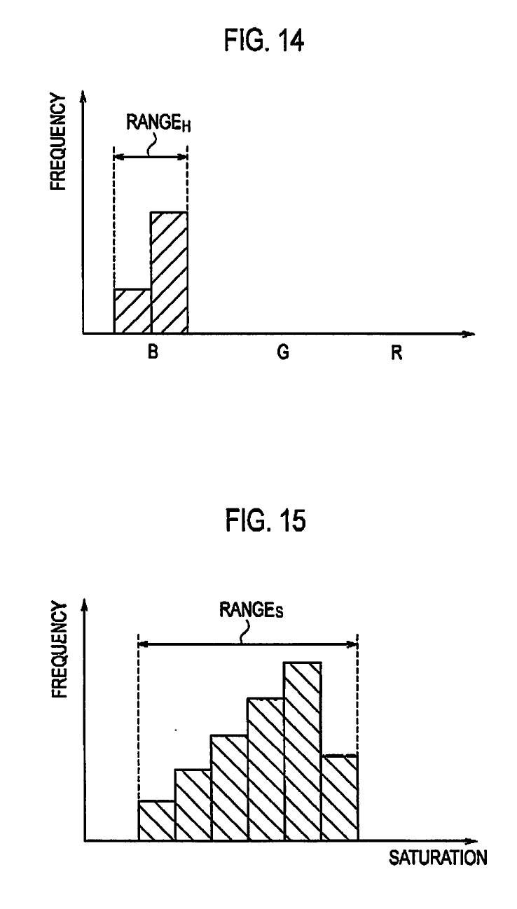

Hereinafter, functions of a projection display apparatus according to the fourth embodiment will be described with reference to the drawings. FIG. 13 is a block diagram depicting functions of a projection display apparatus 100 (signal processing apparatus 200) according to the fourth embodiment. In FIG. 13, like constituent elements shown in FIG. 14 are designated by like reference numerals.

As shown in FIG. 13, in addition to the constituent elements shown in FIG. 14, the signal processing apparatus 200 has an acquisition unit 250.

The acquisition unit 250 acquires various items of information by pixel (m, n) in accordance with an image input signal. Specifically, the acquisition unit 250 acquires: (1) hue of a pixel (m, n) configuring an image (frame); and (2) saturation of the pixel (m, n) configuring an image (frame).

Here, the above-described ratio control unit 230 acquires a parameter γ by image (frame) in accordance with the hue distribution range RANGE_{H} and the saturation distribution range RANGE_{S} in a specific hue (blue hue in this case). The hue distribution range RANGE_{H} is a distributed range of the hues acquired by the acquisition unit 250 in the specific hue. The saturation distribution range RANGE_{S} is a distributed range of the saturations acquired by the acquisition unit 250 in the specific hue.

The ratio control unit 230, for example, as shown in FIG. 14, can acquire the hue distribution range RANGE_{H} by graphically depicting, as a histogram, a frequency of the hues acquired by the acquisition unit 250.

The ratio control unit 230, for example, as shown in FIG. 15, can acquire the saturation distribution range RANGE_{S} by graphically depicting, as a histogram, a frequency of the saturations acquired by the acquisition unit 250.

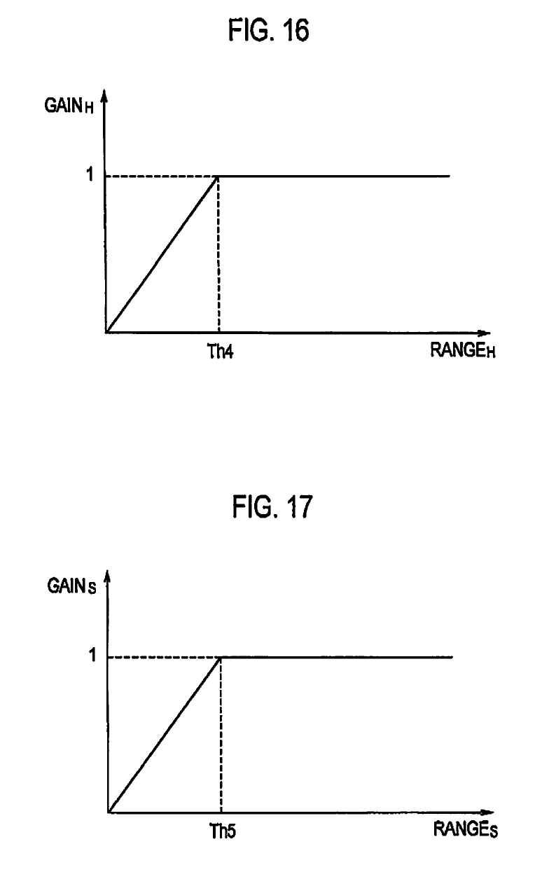

Subsequently, the ratio control unit 230, for example, as shown in FIG. 16, acquires a hue gain GAIN_{H} in accordance with the hue distribution range RANGE_{H}. The hue gain GAIN_{H} is acquired as a higher value, as the hue distribution range RANGE_{H} is wider until the hue distribution range RANGE_{H} is acquired as a threshold value Th4. On the other hand, the hue gain GAIN_{H} is maintained at its maximum value (=1) if the hue distribution range RANGE_{H} exceeds the threshold value Th4. The hue gain GAIN_{H} is a value which ranges from 0 to 1.

The ratio control unit 230, as shown in FIG. 17, acquires a saturation gain GAIN_{S} in accordance with the saturation distribution range RANGE_{S}. The saturation gain GAIN_{S} is acquired as a higher value, as the saturation distribution range RANGE_{S} is wider until the saturation distribution range RANGE_{S} is acquired as a threshold value Th5. On the other hand, the saturation gain GAINS is maintained at its maximum value (=1) if the saturation distribution range RANGE_{S} exceeds the threshold value Th5. The saturation gain GAIN_{S} is a value which ranges from 0 to 1.

Next, the ratio control unit 230 acquires a parameter γ corresponding to an image (frame) in accordance with the hue gain GAIN_{H} and the saturation gain GAIN_{S}. For example, the ratio control unit 230 acquires the parameter γ corresponding to an image in accordance with formula (7) below.

[Formula 7]

γ=GAIN_{H}×GAIN_{S} Formula (7)

Therefore, the ratio control unit 230 increases the contribution degree of luminance components and decreases the contribution degree of color coordinate adjustment as the hue distribution range RANGE_{H} is wider. In addition, the ratio control unit 230 increases the contribution degree of luminance components and reduces the contribution degree of color coordinate adjustment as the saturation distribution range RANGE_{S} is wider.

The display element control unit 240 controls a ratio of a color coordinate adjustment signal and a luminance adjustment signal about an image (frame) in accordance with the parameter γ acquired from the ratio control unit 230.

For example, the display element control unit 240 acquires an image output signal in accordance with formula (8) below.

$$\begin{matrix}[ Formula 8 ] & \\ ( \begin{matrix}{R}_{out} \\ {G}_{out} \\ {B}_{out}\end{matrix} ) = ( 1 - γ ) \times ( \begin{matrix}{R}_{S} \\ {G}_{S} \\ {B}_{S}\end{matrix} ) + γ \times ( \begin{matrix}{R}_{L} \\ {G}_{L} \\ {B}_{L}\end{matrix} ) & Formula ( 8 )\end{matrix}$$

### FUNCTION(S) AND ADVANTAGEOUS EFFECT(S)

In the fourth embodiment, the ratio control unit 230 acquires a parameter γ corresponding to an image (frame) in accordance with a hue distribution range and a saturation distribution range.

Specifically, the ratio control unit 230 increases the contribution degree of luminance components and reduces the contribution degree of color coordinate adjustment as the hue distribution range RANGE_{H} in a specific hue (blue hue in this case) is wider. Thus, a hue difference between pixels in the specific hue can be restrained from being reduced. Therefore, an occurrence of a color gradation collapse in an image (frame) can be restrained.

In addition, the ratio control unit 230 increases the contribution degree of luminance components and reduces the contribution degree of color coordinate adjustment as the saturation distribution range RANGE_{S} in a specific hue (blue hue in this case) is wider. Therefore, a saturation difference between pixels in the specific hue can be restrained from being reduced. Accordingly, the occurrence of a color gradation collapse in an image can be restrained.

### Fifth Embodiment

Hereinafter, a fifth embodiment will be described with reference to the drawings. Hereinafter, differences between the first embodiment described above and the fifth embodiment will be mainly described.

Specifically, the above-described control ratio (α) of the contribution degree of luminance components, according to the first embodiment, is defined in accordance with the counted value of the determination counter. In contrast to this, a control ratio (α_{(m, n)}) of the contribution degree of luminance components, according to the fifth embodiment, is defined on a pixel-by-pixel basis in accordance with a luminance gain (GAIN_{L(m, n)}), a hue gain (GAIN_{H(m, n)}), and a saturation gain (GAIN_{S(m, n)}) which are acquired on the pixel-by-pixel basis.

(Functions of Projection Display Apparatus)

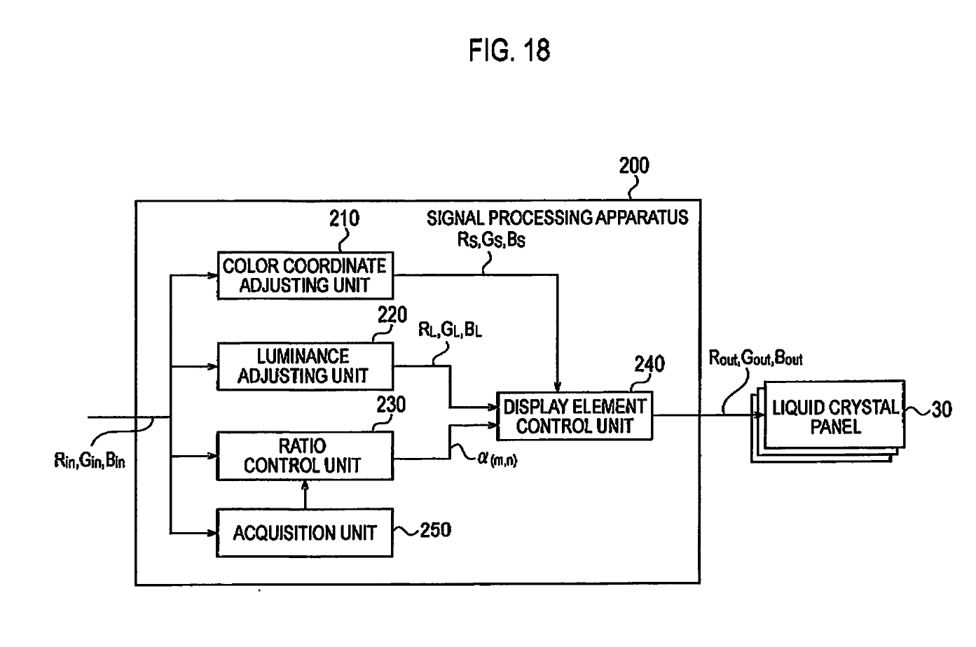

Hereinafter, functions of a projection display apparatus according to the fifth embodiment will be described with reference to the drawings. FIG. 18 is a block diagram depicting functions of a projection display apparatus 100 (signal processing apparatus 200) according to the fifth embodiment. In FIG. 18, like constituent elements shown in FIG. 4 are designated by like reference numerals.

As shown in FIG. 18, in addition to the constituent elements shown in FIG. 4, the signal processing apparatus 200 has an acquisition unit 250.

The acquisition unit 250 acquires various items of information by pixel (m, n) in accordance with an image input signal. Specifically, the acquisition unit 250 acquires: (1) luminance of a pixel (m, n) configuring an image (frame); (2) hue of the pixel (m, n) configuring an image (frame); and (3) saturation of the pixel (m, n) configuring an image (frame). Here, the above-described ratio control unit 230 acquires a parameter α_{(m, n)} corresponding to the pixel (m, n), in accordance with the luminance, hue, and saturation.

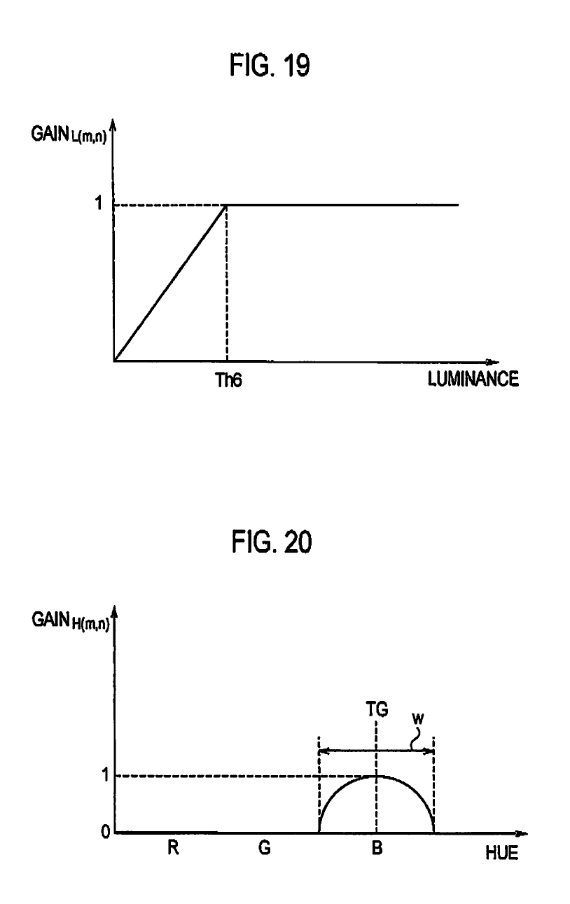

Specifically, the ratio control unit 230, as shown in FIG. 19, acquires a luminance gain (GAIN_{L(m, n)}) in accordance with the luminance of the pixel (m, n). The luminance gain (GAIN_{L(m, n)}) is acquired as a higher value, as the luminance is higher. The ratio control unit 230 maintains a value of the luminance gain (GAIN_{L(m, n)}) at its maximum value (=1) if the luminance exceeds a threshold value Th6. The ratio control unit 230, as shown in FIG. 20, acquires a hue gain (GAIN_{H(m, n)}) in accordance with the hue of the pixel (m,n). Here, a specific hue (blue hue in this case) has a predetermined hue range ω including a target hue TG. The hue gain (GAIN_{H(m, n)}) is acquired as a higher value as the hue is closer to the target hue TG. The hue gain (GAIN_{H(m, n)}) is a value ranging 0 to 1.

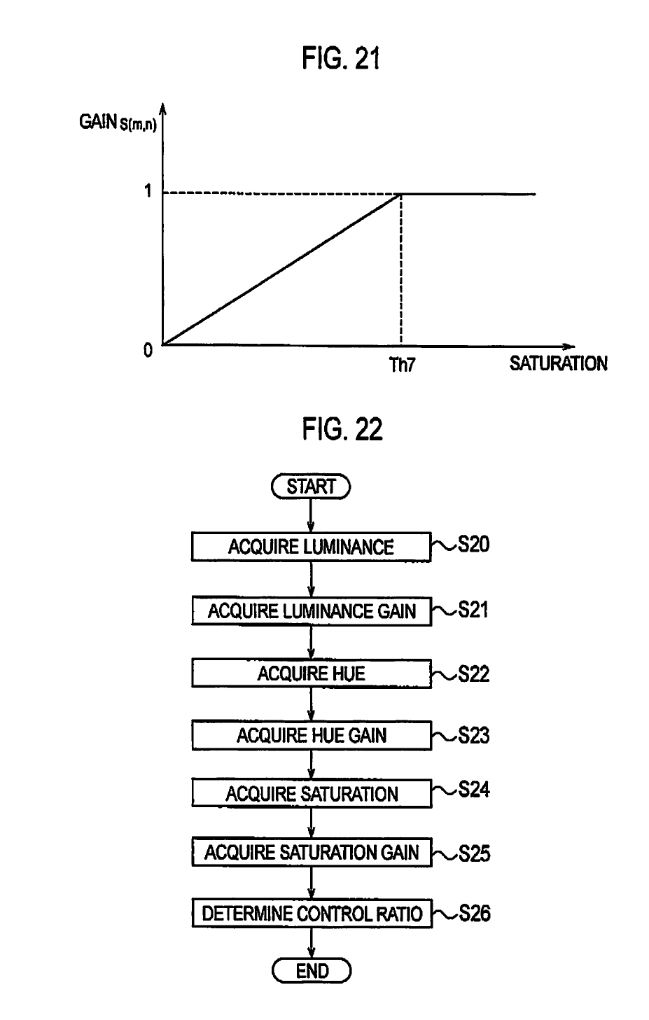

The ratio control unit 230, as shown in FIG. 21, acquires a saturation gain (GAIN_{S(m, n)}) in accordance with saturation of the pixel (m, n). The saturation gain (GAIN_{S(m, n)}) is acquired as a higher value, as the saturation is higher, until it is obtained as the threshold value Th7. On the other hand, the saturation gain (GAIN_{S(m, n)}) is maintained at its maximum value (=1) if the saturation exceeds a threshold value Th7. The saturation gain (GAIN_{S(m, n)}) is a value which ranges from 0 to 1.

Subsequently, the ratio control unit 230 acquires a parameter α_{(m, n)} corresponding to the pixel (m, n), in accordance with the luminance gain (GAIN_{L(m, n)}), the hue gain (GAIN_{H(m, n)}), and the saturation gain (GAIN_{S(m, n)}). For example, the ratio control unit 230 acquires the parameter α_{(m, n)} corresponding to the pixel (m, n), in accordance with formula (9) below.

[Formula 9]

α_{(m,n)}=GAIN_{L(m,n)}×GAIN_{H(m,n)}×GAIN_{S(m,n)} Formula(9)

In this way, the ratio control unit 230 increases the contribution degree of luminance components and reduces the contribution degree of color coordinate adjustment as the luminance is higher. In addition, the ratio control unit 230 increases the contribution degree of luminance components and reduces the contribution degree of color coordinate adjustment as the hue is closer to the target hue TG. Further, the ratio control unit 230 increases the contribution degree of luminance components and reduces the contribution degree of color coordinate adjustment, as the saturation is higher.

The display element control unit 240 controls a ratio of a color coordinate adjustment signal and a luminance adjustment signal by pixel (m, n) in accordance with the parameter α_{(m, n)} acquired from the ratio control unit 230.

(Operation of Projection Display Apparatus)

Hereinafter, an operation of the projection display apparatus according to the fifth embodiment will be described with reference to the drawings. FIG. 22 is a flowchart showing functions of the projection display apparatus 100 (signal processing apparatus 200) according to the fifth embodiment.

As shown in FIG. 22, in step 20, the signal processing apparatus 200 acquires a luminance of a pixel (m, n) configuring an image (frame), in accordance with an image input signal.

In step 21, the signal processing apparatus 200 acquires a luminance gain (GAIN_{L(m, n)}) in accordance with the luminance acquired in step 20.

In step 22, the signal processing apparatus 200 acquires hue of the pixel (m, n) configuring an image (frame), in accordance with an image input signal.

In step 23, the signal processing apparatus 200 acquires a hue gain (GAIN_{H(m, n)}) in accordance with the hue acquired in step 22.

In step 24, the signal processing apparatus 200 acquires saturation of the pixel (m, n) configuring an image (frame), in accordance with an image input signal.

In step 25, the signal processing apparatus 200 acquires a saturation gain (GAIN_{S(m, n)}) in accordance with the saturation acquired in step 24.

In step 26, the signal processing apparatus 200 determines a control ratio (α_{(m, n)}) of the contribution degree of color coordinate adjustment and the contribution degree of luminance component. Specifically, the signal processing apparatus 200 determines a parameter α_{(m, n)} corresponding to a pixel (m, n), in accordance with a respective one of the gains that are acquired in step 21, step 23, and step 25. It should be noted that the signal processing apparatus 200 performs processing of step 20 to step 26 as to all of the pixels each configuring an image (frame).

### FUNCTION(S) AND ADVANTAGEOUS EFFECT(S)

In the fifth embodiment, the ratio control unit 230 acquires the parameter α_{(m, n)} on a pixel-by-pixel basis configuring an image (frame), in accordance with a luminance, hue, and saturation. The display element control unit 240 controls a ratio of a color coordinate adjustment signal and a luminance adjustment signal on the pixel-by-pixel basis.

Therefore, in a specific hue (blue hue in this case), it is possible to lower the luminance as to only the pixel in which a glare occurs and to restrain reduction of a color coordinate. As a result, the restraint of the glare can be compatible with effective use of a color space of a liquid crystal panel 30 over an entire image.

### Other Embodiments

Although the present invention has been described by way of the foregoing embodiments, it should not be understood that the statement and drawings forming part of this disclosure limits this invention. From this disclosure, a variety of substitutive embodiments, examples, and applicable techniques would have been apparent to one skilled in the art.

Although not set forth in the foregoing embodiments in particular, a control ratio of the contribution degree of luminance components may be defined based upon the parameter β according to the third embodiment and the parameter α_{(m, n)} according to the fifth embodiment. Specifically, a multiplication value obtained by multiplexing these parameters is employed as the control ratio of the contribution degree of luminance components. In this manner, even in a case where a specific hue (blue hue in this case) exists in only a small part of a image (frame), the restraint of the glare in pixels of the specific hue can be compatible with effective use of the color space of the liquid crystal panel 30.

While, in the second embodiment described above, a luminance average value was employed in acquisition of a parameter Lum, it is not limitative thereto. A total value of luminances of the pixels each configuring an image (frame) may be employed in acquisition of the parameter Lum.

While, in the third embodiment described above, a parameter β was defined by a hue gain GAIN_{H} and a saturation gain GAIN_{S}, it is not limitative thereto. The parameter β may be defined by either the hue gain GAIN_{H} or the saturation gain GAIN_{S}.

While, in the fourth embodiment described above, a parameter γ was defined by a hue distribution range RANGER and a saturation distribution range RANGE_{S}, it is not limitative thereto. The parameter γ may be defined by either the hue distribution range RANGER or the saturation distribution range RANGE_{S}.

While, in the fifth embodiment described above, a luminance gain (GAIN_{L(m, n)}) was employed in acquisition of a parameter α_{(m, n)}, it is not limitative thereto. A total value or an average value of luminances of the pixels each configuring an image (frame) may be employed in acquisition of the parameter α_{(m, n)}.

While, in the fifth embodiment described above, a parameter α_{(m, n)} was defined by a luminance gain (GAIN_{L(m, n)}), a hue gain (GAIN_{H(m, n)}), and a saturation gain (GAIN_{S(m, n)}), it is not limitative thereto. The parameter α_{(m, n)} may be defined by any of the luminance gain (GAIN_{L(m, n)}), the hue gain (GAIN_{H(m, n)}), and the saturation gain (GAIN_{S(m, n)}). For example, the parameter α_{(m, n)} may be defined by only the luminance gain (GAIN_{L(m, n)}). The parameter α_{(m, n)} may also be defined by only the hue gain (GAIN_{H(m, n)}). Further, the parameter α_{(m, n)} may be defined by only the saturation gain (GAIN_{S(m, n)}).

While, in the third and fifth embodiments described above, a correlation between hue and hue gain (GAIN_{H(m, n)}) was explained with reference to FIG. 10 and FIG. 20, it is not limitative to the graph formats shown in FIG. 10 and FIG. 20. The hue and the hue gain (GAIN_{H(m, n)}) may be in a relationship in which the hue gain (GAIN_{H(m, n)}) is obtained as a higher value as the hue is closer to the target hue TG.

While, in the foregoing embodiments, a liquid crystal panel 30 was employed as a display device, it is not limitative thereto. An LCOS (Liquid Crystal on Silicon) or a DMD (Digital Micromirror Device) and the like may be employed as a display device.

While, in the foregoing embodiments, a solid light source was employed as a light source, it is not limitative thereto. A UHP lamp, which emits incandescent light, may be employed as a light source.

### INDUSTRIAL APPLICABILITY

According to the present invention, there can be provided a signal processing apparatus and a projection display apparatus, which are capable of effectively utilizing a color space of the display device while restraining a difference between an image color coordinate and a real color coordinate to a certain extent.

1. A signal processing apparatus configured to convert an image input signal to an image output signal and output the image output signal to a display device, the signal processing apparatus comprising:
a color coordinate adjusting unit configured to perform a color coordinate adjusting processing of adjusting a color coordinate of the image input signal, in accordance with a color space of the display device;
a luminance adjusting unit configured to perform a luminance adjusting processing of adjusting a luminance component of the image input signal;
an output signal generating unit configured to generate the image output signal, in accordance with the color coordinate adjusted by the color coordinate adjusting processing and the luminance component adjusted by the luminance adjusting processing; and
a control unit configured to control a contribution degree of color coordinate adjustment, which the color coordinate adjusting processing imparts to the image output signal, and a contribution degree of a luminance component, which the luminance adjusting processing imparts to the image output signal, in accordance with saturation of the image input signal, wherein
the control unit increases the contribution degree of the luminance component and reduces the contribution degree of the color coordinate adjustment, as the saturation of the image input signal is higher in a specific hue.

2. The signal processing apparatus according to claim 1, further comprising an acquisition unit configured to acquire a luminance of an image in accordance with the image input signal, wherein
the control unit lowers amount of the luminance component of the image input signal in the luminance adjusting processing, as the luminance acquired by the acquisition unit is higher.

3. The signal processing apparatus according to claim 1, further comprising an acquisition unit configured to acquire a hue in a respective one of pixels configuring an image, in accordance with the image input signal, wherein
the specific hue has a predetermined hue range including a target hue; and
the control unit increases the contribution degree of the luminance component and reduces the contribution degree of the color coordinate adjustment, as the hue acquired by the acquisition unit is closer to the target hue.

4. The signal processing apparatus according to claim 1, further comprising an acquisition unit configured to acquire a hue in a respective one of pixels configuring an image, in accordance with the image input signal, wherein
the control unit increases the contribution degree of the luminance component and reduces the contribution degree of the color coordinate adjustment, as a hue distribution range is wider, the hue distribution range is a distributed range of the hue acquired by the acquisition unit in the specific hue.

5. The signal processing apparatus according to claim 1, further comprising an acquisition unit configured to acquire saturation in a respective one of pixels configuring an image, in accordance with the image input signal, wherein
the control unit increases the contribution degree of the luminance component and reduces the contribution degree of the color coordinate adjustment, as the saturation acquired by the acquisition unit is higher.

6. The signal processing apparatus according to claim 1, further comprising an acquisition unit configured to acquire saturation in a respective one of pixels configuring an image, in accordance with the image input signal, wherein
the control unit increases the contribution degree of the luminance component and reduces the contribution degree of the color coordinate adjustment, as a saturation distribution range is wider, the saturation distribution range is a distributed range of the saturation acquired by the acquisition unit in the specific hue.

7. The signal processing apparatus according to claim 1, wherein
the control unit controls the contribution degree of the luminance component and the contribution degree of the color coordinate adjustment in a respective one of pixels.

8. A projection display apparatus, comprising:
a signal processing apparatus recited in claim 1;
a display device for displaying an image in accordance with an image output signal outputted from the signal processing apparatus; and
a projection means for projecting the image displayed by the display device.
